(19) United States
(12) Patent Application Publication
(10) Pub. No.: US 2024/0086164 A1
(43) Pub. Date: Mar. 14, 2024

(54) GENERATING SYNTHETIC TRAINING DATA FOR PROGRAMMING LANGUAGE TRANSLATION

(71) Applicant: Google LLC, Mountain View, CA (US)

(72) Inventors: Lucas Kramer, Minneapolis, MN (US); Bin Ni, Fremont, CA (US)

(21) Appl. No.: 17/940,618

(22) Filed: Sep. 8, 2022

(51) Int. Cl. G06F 8/51; G06F 8/36; G06N 20/00

(52) U.S. Cl. CPC G06F 8/51; G06F 8/36; G06N 20/00

(57) ABSTRACT

Techniques are described herein for generating synthetic paired source code snippets that are semantically equivalent but syntactically distinct. In various implementations, few shot learning may be performed to prompt a large language model, based on demonstration source code snippet(s) in syntactically constrained pseudocode, to generate additional source code snippets in the syntactically constrained pseudocode. Based on additional source code snippets in additional programming language(s), the large language model may be used to generate more training source code snippets in the syntactically constrained pseudocode. The training source code snippets in the syntactically constrained pseudocode may be programmatically translated to generate synthetic training pairs of semantically equivalent source code snippets. Each synthetic training pair of the plurality of synthetic training pairs may include training snippets in first and second programming languages, and may be usable to train a machine learning translation model to translate between the first and second programming languages.

### BACKGROUND

Computer software programming often requires developers to read and/or write source code (i.e., to program) in a specific language, e.g. Java, C++, C, Python, etc. Each programming language has its own strengths, weaknesses, nuances, idiosyncrasies, etc. Most programmers obtain at least a superficial understanding of multiple programming languages, but only master a few. Consequently, each programming language tends to have its own talent pool. Language models such as transformer networks have become increasingly popular for translating between programming languages. Training a language model to translate between different programming languages requires and/or benefits from supervised training data. This supervised training data may include pairs of semantically equivalent source code examples (referred to herein as “snippets”) in different languages. However, curating a supervised dataset can be expensive both in terms of time and cost.

### SUMMARY

Implementations are described herein for leveraging data synthesis to reduce the costs associated with curating supervised training data for training a programming language translation model. More particularly, but not exclusively, implementations are described herein for generating synthetic paired source code snippets that are semantically equivalent but syntactically distinct. In various implementations, a large language model and an intermediate programming language, e.g., syntactically constrained pseudocode, may be used to quickly generate many pairs of semantically equivalent synthetic source code snippets in different programming languages. Because this large language model is trained based at least in part on corpuses of real-life source code, the resulting paired source code snippets are realistic as well.

In some implementations, a method may be implemented by one or more processors and may include: performing few shot learning to prompt a large language model based on one or more demonstration source code snippets in syntactically constrained pseudocode, wherein the few shot learning prompts the large language model to generate additional source code snippets in the syntactically constrained pseudocode; based on a plurality of additional source code snippets in one or more additional programming languages, using the large language model to generate a plurality of training source code snippets in the syntactically constrained pseudocode, wherein the training source code snippets in the syntactically constrained pseudocode are semantically-equivalent to the plurality of additional source code snippets in the one or more additional programming languages; and programmatically translating the plurality of training source code snippets in the syntactically constrained pseudocode to generate a plurality of synthetic training pairs of semantically equivalent source code snippets, wherein each synthetic training pair of the plurality of synthetic training pairs includes a first training snippet in a first programming language and a second training snippet in a second programming language; wherein the plurality of synthetic training pairs of semantically equivalent source code snippets are usable to train a machine learning translation model to translate between the first and second programming languages.

In various implementations, the one or more demonstration source code snippets in the syntactically constrained pseudocode may be paired with semantically equivalent source code snippets in a reference programming language. In various implementations, the few shot learning prompts the large language model to translate from the reference programing language to the syntactically constrained pseudocode. In various implementations, the plurality of additional source code snippets in the one or more additional programming language may include a plurality of source code snippets in the reference programming language.

In various implementations, the plurality of additional source code snippets may be part of a corpus of source code used to train the large language model prior to the few shot learning. In various implementations, programmatically translating the plurality of training source code snippets in the syntactically constrained pseudocode may include checking syntaxes of the training source code snippets in the syntactically constrained pseudocode. In various implementations, programmatically translating the plurality of training source code snippets in the syntactically constrained pseudocode may include discarding the training source code snippets in the syntactically constrained pseudocode with invalid syntaxes.

In various implementations, programmatically translating the plurality of training source code snippets in the syntactically constrained pseudocode may include, for each of the training source code snippets in the synthetically constrained pseudocode: generating a first abstract syntax tree; transforming the first abstract syntax tree to a second abstract syntax tree; and traversing the second abstract syntax tree to generate the first training snippet in the first programming language for a respective synthetic training pair.

In various implementations, the first programming language may be the reference programming language. In various implementations, the second programming language may be a different version of the reference programming language. In various implementations, the second programming language may be a different programming language than the reference programming language.

In various implementations, programmatically translating the plurality of training source code snippets may include converting a generic map, filter, or reduce statement in the syntactically constrained pseudocode to a first programming language idiom in the first training snippet. In various implementations, programmatically translating the plurality of training source code snippets may include converting the generic map, filter, or reduce statement in the syntactically constrained pseudocode to a second programming language idiom in the second training snippet.

In various implementations, programmatically translating the plurality of training source code snippets may include programmatically translating the same training source code snippet to the first programming language multiple times, each time with different translation parameter(s), to generate multiple semantically-equivalent-but-syntactically-distinct source code snippets in the first programming language. In various implementations, each of the multiple semantically-equivalent-but-syntactically-distinct source code snippets in the first programming language may be paired with a semantically equivalent source code snippet in the second programming language to form one of the plurality of synthetic training pairs.

In addition, some implementations include one or more processors of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 schematically depicts an example environment in which selected aspects of the present disclosure may be implemented, in accordance with various implementations.

FIG. 2 schematically depicts an example of how various components configured with selected aspects of the present disclosure may carry out techniques described herein, in accordance with various implementations.

FIG. 3, FIG. 4, FIG. 5, and FIG. 6 depict examples of source code snippets that are processed, translated, and/or generated in accordance with implementations described herein.

FIG. 7 depicts a flowchart illustrating an example method for practicing selected aspects of the present disclosure.

FIG. 8 illustrates an example architecture of a computing device.

### DETAILED DESCRIPTION

Implementations are described herein for leveraging data synthesis to reduce the costs associated with curating supervised training data for training a programming language translation model. More particularly, but not exclusively, implementations are described herein for generating synthetic paired source code snippets that are semantically equivalent but syntactically distinct. In various implementations, a large language model and an intermediate programming language, e.g., syntactically constrained pseudocode, may be used to quickly generate many pairs of semantically equivalent synthetic source code snippets in different programming languages. Because this large language model is trained based at least in part on corpuses of real-life source code, the resulting paired source code snippets are realistic as well.

In various implementations, the large language model may be “prompted” with one or more demonstrations in a process known as “few shot learning.” These demonstrations may be selected to “condition” or “prime” the large language model to process subsequent input in a similar fashion as shown in the demonstration(s). In some implementations, the large language model may be prompted with one or more pairs of demonstration source code snippets. Each pair of demonstration source code snippets may include one demonstration snippet in the syntactically constrained pseudocode and another demonstration snippet in a reference programming language, such as Python, Java, or even a particular version of a programming language (e.g., Python 3.10).

Once the large language model is “prompted” or “primed,” it may be used to generate a plurality of source code snippets in the syntactically constrained pseudocode (referred to herein as “training source code snippets in the syntactically constrained pseudocode”). In some implementations, after prompting, the large language model may be explicitly provided, for translation to the syntactically constrained pseudocode, additional source code snippets in the reference programming language. In other implementations, the large language model may be prompted with a series of unpaired demonstration source code snippets in the syntactically constrained pseudocode. It does not matter whether the large language model has been trained on syntactically constrained pseudocode code examples previously (although that may improve its performance). Then, the large language model may be used to create additional demonstration source code snippets in the syntactically constrained pseudocode based on example source code snippets the large language model has “seen” previously during training.

However the training source code snippets in the syntactically constrained pseudocode are generated, they may then be programmatically translated into synthetic pairs of semantically equivalent training source code snippets in different programming languages. As used herein, “programmatic translation” refers to translation that is performed not with a statistical and/or machine learning model, but instead using rules and/or heuristics. For instance, techniques sometimes associated with compilers may be used to convert training source code snippets in the syntactically constrained pseudocode to data structures such as abstract syntax trees (ASTs) or control flow graphs (CFGs). These data structures and/or their constituent components (e.g., nodes)—which are programming language agnostic initially—may then be transformed into programming language specific data structures and/or components. Each resulting AST or CFG may then be traversed to generate a source code snippet in a particular programming language.

The synthetic pairs of semantically equivalent training source code snippets may then be used to conduct supervised training of another machine learning model, such as a neural translation model, to translate source code between the respective programming languages of the training source code snippets in the synthetic training pairs.

In many cases, some of the training source code snippets in the syntactically constrained pseudocode may include syntactic and/or semantic errors. For example, after few shot learning, the large language model may generate, from an unpaired source code snippet in the reference programming language, a training source code snippet in the syntactically constrained pseudocode that includes one or more syntactic and/or semantic errors. These errors may be handled in various ways.

In some implementations, syntaxes of the training source code snippets in the syntactically constrained pseudocode may be checked during programmatic translation, e.g., by a lexical analyzer, parser, and/or syntax checker of the programmatic translator. Likewise, semantics of source code snippets may be checked during programmatic translation, e.g., by a semantic analyzer of the programmatic translator that verifies whether a parse tree is meaningful. In some implementations, type checking may also be performed. In some such implementations, the training source code snippets with invalid syntaxes, semantic errors, and/or type mismatches may simply be discarded. Very large numbers of total training source code snippets (e.g., millions, tens of millions) can be generated relatively quickly using techniques described herein. Accordingly, even if a large fraction of the training source code snippets have syntax errors and are discarded, large numbers of “clean” training source code snippets may remain to train the machine learning translation model.

Techniques described herein may enable idiomatic translation between different programming languages and/or within the same programming language. In particular, the large language model may learn (e.g., through training and/or few shot learning) mappings between generic functions in the syntactically constrained pseudocode and programming language-specific code snippets with equivalent semantic roles. As an example, the map, filter, or reduce operations may be defined generically in the syntactically constrained pseudocode. But when programmatically translated into different programming languages, these operations may be translated into one or more source code snippets in each programming language, with each source code snippet performing a semantically equivalent role as the map, filter, or reduce operations.

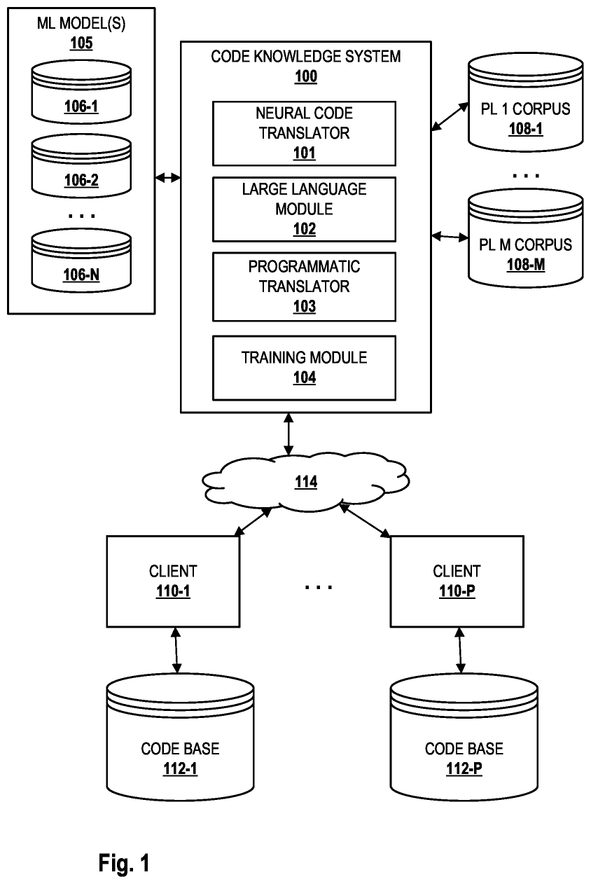

FIG. 1 schematically depicts an example environment in which selected aspects of the present disclosure may be implemented, in accordance with various implementations. Any computing devices depicted in FIG. 1 or elsewhere in the figures may include logic such as one or more microprocessors (e.g., central processing units or “CPUs”, graphical processing units or “GPUs”, tensor processing units or “TPUs”) that execute computer-readable instructions stored in memory, or other types of logic such as application-specific integrated circuits (“ASIC”), field-programmable gate arrays (“FPGA”), and so forth. Some of the systems depicted in FIG. 1, such as a code knowledge system 100, may be implemented using one or more server computing devices that form what is sometimes referred to as a “cloud infrastructure,” although this is not required.

A code knowledge system 100 may be provided for helping clients 110-1 to 110-P manage their respective code bases 112-1 to 112-P. Code knowledge system 100 may include, among other things, a neural code translator 101 that is configured to help one or more clients 110-1 to 110-P to translate source code stored in one or more corresponding code bases 112-1 to 112-P. Each client 110 may be, for example, an entity or organization such as a business (e.g., financial institute, bank, etc.), non-profit, club, university, government agency, or any other organization that operates one or more software systems. For example, a bank may operate one or more software systems to manage the money under its control, including tracking deposits and withdrawals, tracking loans, tracking investments, and so forth. An airline may operate one or more software systems for booking/canceling/rebooking flight reservations, managing delays or cancellations of flight, managing people associated with flights, such as passengers, air crews, and ground crews, managing airport gates, and so forth.

Neural code translator 101 may be configured to leverage knowledge of multiple different programming languages to aid clients 110-1 to 110-P in translating between programming languages when editing, updating, re-platforming, migrating, or otherwise acting upon their code bases 112-1 to 112-P. For example, neural code translator 101 may be configured to use one or more machine learning models 106 to translate code snippets from one programming language to another, e.g., on the fly or in batches. This may, for instance, enable a developer fluent in a first programming language to view and/or edit source code that was originally written in a second, less-familiar programming language in the first programming language. It may also significantly decrease the time and/or costs associated with migrating code bases 112 between different programming languages.

In various implementations, code knowledge system 100 may include a machine learning (“ML” in FIG. 1) database 105 that includes data indicative of one or more trained machine learning models 106-1 to 106-N. These trained machine learning models 106-1 to 106-N may take various forms that will be described in more detail below, including but not limited to BERT (Bidirectional Encoder Representations from Transformers) transformers, GPT (Generative Pre-trained Transformer) transformers, a graph-based network such as a graph neural network (“GNN”), graph attention neural network (“GANN”), graph convolutional neural network (“GCN”), or graph attention network (“GAT”), other types of sequence-to-sequence models and/or encoder-decoders, various flavors of a recurrent neural network (“RNN”, e.g., long short-term memory, or “LSTM”, gate recurrent units, or “GRU”, etc.), and any other type of machine learning model that may be applied to facilitate selected aspects of the present disclosure.

In some implementations, code knowledge system 100 may also have access to one or more programming-language-specific corpuses 108-1 to 108-M. In some implementations, these programming-language-specific corpuses 108-1 to 108-M may be used, for instance, to train one or more of the machine learning models 106-1 to 106-N. In some implementations, the programming-language-specific corpuses 108-1 to 108-M may include examples of source code (e.g., entire code bases, libraries, etc), inline comments, textual metadata associated with source code (e.g., commits), documentation such as textbooks and programming manuals, programming language-specific discussion threads, presentations, academic papers, and so forth.

In some implementations, a client 110 that wishes to enable manipulation of its code base 112 in programming language(s) other than that/those used originally to write the source code may establish a relationship with an entity (not depicted in FIG. 1) that hosts code knowledge system 100. When a developer wishes to view/edit a source code snippet of the entity's code base 112 but is unfamiliar with the native programming language, neural code translator 101 may provide one or more versions of the source code snippet that is translated to a target programming language preferred by the developer. In some such implementations, neural code translator 101 may generate the translated source code snippet on the fly, e.g., in real time. In other implementations, neural code translator 101 may operate, e.g., in a batch mode, to preemptively translate all or selection portions of an entity's code base 112 into a targeted programming language. In some implementations in which the developer then edits the translated source code snippet, the edited version may be translated back into the native programming language or left in the new, target programming language, assuming other necessary infrastructure is in place.

Neural code translator 101 may utilize various machine learning models, including various types of neural networks such as neural translation models, to translate between different programming languages, or in some cases, to translate between different versions of the same programming language. As noted above, obtaining paired training data to train these neural translation models can be challenging. Accordingly, code knowledge system 100 includes various other components that can aid in the automatic and/or systematic generation of large numbers of paired synthetic source code examples.

A large language module 102 may be configured to leverage a large language model 106 to perform natural language processing (“NLP”). The large language model 106 may take various forms, such as the aforementioned BERT transformer, GPT-X (e.g., GPT-1, GPT-2, GPT-3, or any subsequent versions thereof), the Pathways Language Model (PaLM), the Language Model for Dialogue Applications (LaMDA), and so forth. Such a language model may be “prompted” with demonstration(s) in a process referred to as “few shot learning.” Consequently, the large language model is effectively “primed” to perform task(s) established by the demonstration(s), e.g., by being more likely to select output candidates that are aligned with the demonstrated task(s).

In some implementations, the large language model 106 may have been trained previously on one or more corpuses 108 related specifically to computer programming, as opposed to general-purpose corpuses such as encyclopedias, newspapers, magazines, etc. These computer programming-related corpuses 108 can include source code (e.g., multiple code bases in a variety of different programming languages) and natural language documentation about computer programming Training the large language model specifically using computer-programming-related corpuses enables the model, upon conditioning with demonstrations as described herein, to generate numerous training examples of intermediate high level source code (also referred to herein as “syntactically constrained pseudocode”). Syntactically constrained pseudocode is high level code (relative to lower-level programming languages such as Python, Jaca, C, C++, etc.) that describes semantic functionality in terms, tokens, and operations that are agnostic/generic to lower-level programing languages. Consequently, while semantically constrained pseudocode may not necessary be capable of direct compilation into executable machine code, it may be programmatically translatable (e.g., in a fashion similar to compilation) to one or more lower-level programming languages, which in turn are capable of being compiled into executable machine code.

Large language module 102 may be configured to generate numerous training examples of syntactically constrained pseudocode in various ways. As one example, large language module 102 may be provided with one or more demonstration pairs of semantically equivalent source code snippets. One of the source code snippets may be written in the syntactically constrained pseudocode, and the other source code snippet may be written in a chosen reference programming language (e.g., chosen because the user has code examples available that perform semantic tasks the user would like translated into multiple different programming languages), such as Python, Java, JavaScript, C, C++, Perl, etc. Large language module 102 may prompt the large language model with these demonstration pairs, so that the large language model is primed or conditioned to translate additional unpaired source code snippets in the reference programming language to syntactically constrained pseudocode.

As another example, large language module 102 may be prompted with unpaired source code snippets in the syntactically constrained pseudocode. Regardless of whether the large language model was trained previously on the syntactically constrained pseudocode, it may nevertheless generate additional examples of source code snippets in the syntactically constrained pseudocode. Instead of being provided example source code snippets in a chosen reference programming language, in some implementations, large language module 102 may select existing source code snippets in lower-level language(s) (e.g., not the syntactically constrained pseudocode) from one or more corpuses 108-1 to 108-M to generate new source code snippets in the syntactically constrained pseudocode. These existing source code snippets may be selected at random, based on semantic task(s) they are intended to perform, based on contextual signals, etc.

A programmatic translator 103 may be configured to programmatically translate, to one or more target programming languages that are typically lower level than the syntactically constrained pseudocode, the plurality of training source code snippets in the syntactically constrained pseudocode that were generated by large language module 102. Based on this translation, programmatic translator 103 may generate, for instance, synthetic training pairs of semantically equivalent source code snippets in different programming languages or in different versions of the same programming language. Assuming there is a desire to train a neural translation model to translate between a first programming language and a second programming language, each synthetic training pair of the plurality of synthetic training pairs may include a first training snippet in the first programming language and a second training snippet in the second programming language.

It may be the case that some, if not a substantial portion, of the plurality of training source code snippets in the syntactically constrained pseudocode include semantic and/or syntactic errors. This may be due, for instance, to the large language model's imperfect ability to translate other programming languages to the syntactically constrained pseudocode. Accordingly, in some implementations, training source code snippets in the syntactically constrained pseudocode may be checked, e.g., by programmatic translator 103, for semantic and/or syntactic errors, and/or for type mismatches (type checking). For example, to program from synthetically constrained pseudocode to various programming languages, programmatic translator 103 may include compiler components such as a lexical analyzer, parser, and/or syntax checker to check for syntax errors, and/or a semantic analyzer that verifies semantic correctness, e.g., based on whether a parse tree is meaningful. In some implementations, training source code snippets determined to have invalid syntaxes, semantic errors, and/or type mismatches may be discarded.

In some implementations, programmatic translator 103 may be configured to translate each of the training source code snippets in the synthetically constrained pseudocode as follows. First, programmatic translator 103 may generate a first abstract syntax tree based on the training source code snippet. Programmatic translator 103 may then transform the first abstract syntax tree (AST) to a second AST, e.g., with components of the first AST being transformed to components that are compatible with the target programming language. Then, programmatic translator 103 may traverse the second AST to generate a training snippet in the target programming language for a respective synthetic training pair.

In some implementations, programmatic translator 103 may be configured to idiomatically translate between programming languages, e.g., by converting generic source code in the syntactically constrained pseudocode to programming language-specific idioms (alternatively, programming language-specific “constructs”) in particular programming languages. For example, programmatic translator 103 may convert a generic map, filter, or reduce expression in the syntactically constrained pseudocode to a first programming language idiom/construct (e.g., streaming API in Java) in the first training snippet and to a second programming language idiom/construct (e.g., list comprehensions in Python) in the second training snippet. That way, the training pair is usable to train a neural translation model to translate directly between the idioms/constructs in the first and second programming languages.

In some implementations, programmatic translator 103 may be configured to translate the same training source code snippet to a target programming language multiple times, each time using different translation parameter(s), to generate multiple semantically-equivalent-but-syntactically-distinct source code snippets in the target programming language. For example, programmatic translator 103 may be invoked via a command line multiple times, each time with different command line parameters specifying how the syntactically constrained pseudocode should be translated. During one invocation, a parameter may instruct programmatic translator 103 to translate pseudocode having generic map/filter/reduce expressions into for loops and/or if/else statements. During another invocation, a parameter may instruct programmatic translator 103 to translate the same pseudocode into list comprehensions/generators. During another invocation, a parameter may instruct programmatic translator 103 to translate the same pseudocode into map/filter/reduce functions that are programming language-specific. Each of the multiple semantically-equivalent-but-syntactically-distinct source code snippets in the target programming language may be paired with a semantically equivalent source code snippet in a second programming language to form one of the plurality of synthetic training pairs that are ultimately used to train the neural translation model. Consequently, the neural translation model may be capable of many-to-one and/or one-to-many translations across programming languages.

Training module 104 may be configured to train a neural translation model (e.g., one of 106-1 to 106-N) based on the pairs of training snippets generated by programmatic translator 103. This neural translation model may then be used by neural code translator 101 as described previously to translated source code snippets between various programming languages.

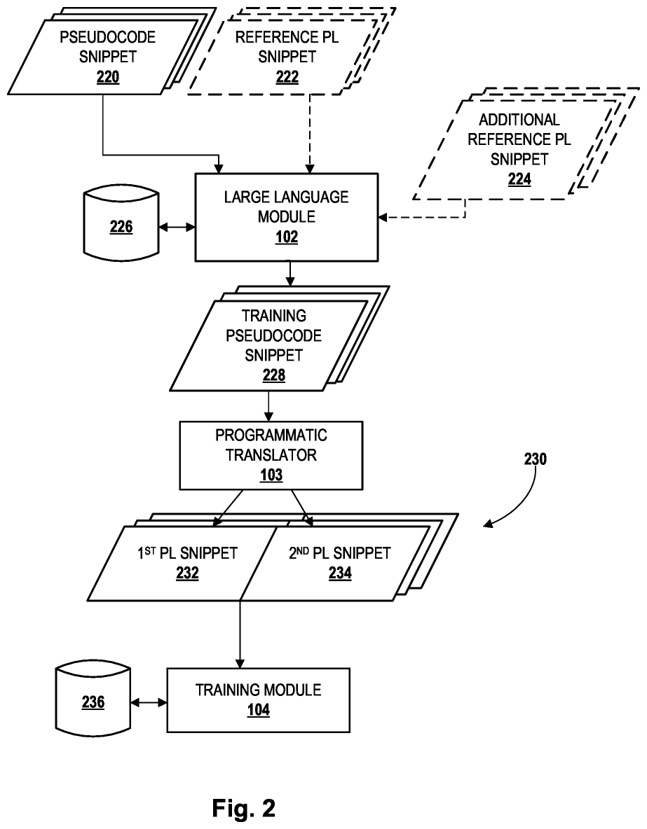

FIG. 2 schematically depicts an example of how components described herein may cooperate to perform selected aspects of the present disclosure. Starting at top, one or more pseudocode snippets 220 may be provided as inputs that large language module 102 uses to prompt large language model 226. For example, a user may manually type pseudocode snippets 220 and/or identify files that contain pseudocode snippets 220 at a command line interface provided by large language module 102. Large language module 102 may process these snippets using large language model 226 as described previously. If no other input is provided, large language module 102 may use large language model 226 to generate training pseudocode snippets 228, e.g., based on source code snippets selected (randomly, systematically, on demand) from one or more code bases 108/112.

However, as indicated by the dashed lines, in some implementations, one or more reference programming language (“PL” in FIG. 2) snippets 222 may also be provided as inputs to large language module 102 in a similar fashion, e.g., to prompt or condition large language model 226. In particular, these inputs may be used to prompt large language model 226 to generate training pseudocode snippets 228 based on other to-be-received inputs, namely, additional reference PL snippet(s) 224 that are provided subsequent to large language model 226 being prompted with inputs 220 and 222. In such a scenario, training pseudocode snippets 228 may be generated based on the additional reference PL snippets 224, in addition to or instead of other PL snippets selected from one or more codebases 108.

This methodology may enable very large numbers of training pseudocode snippets 228 to be generated automatically (with little or no human intervention) in a relatively short amount of time. These large numbers of training pseudocode snippets 228 may then be processed by programmatic translator 103 to generate synthetic training pairs 230 of source code snippets 232 and 234. Synthetic training pairs 230 may then be used by training module 104 to train one or more neural translation models 236 to translate source code between various programming languages.

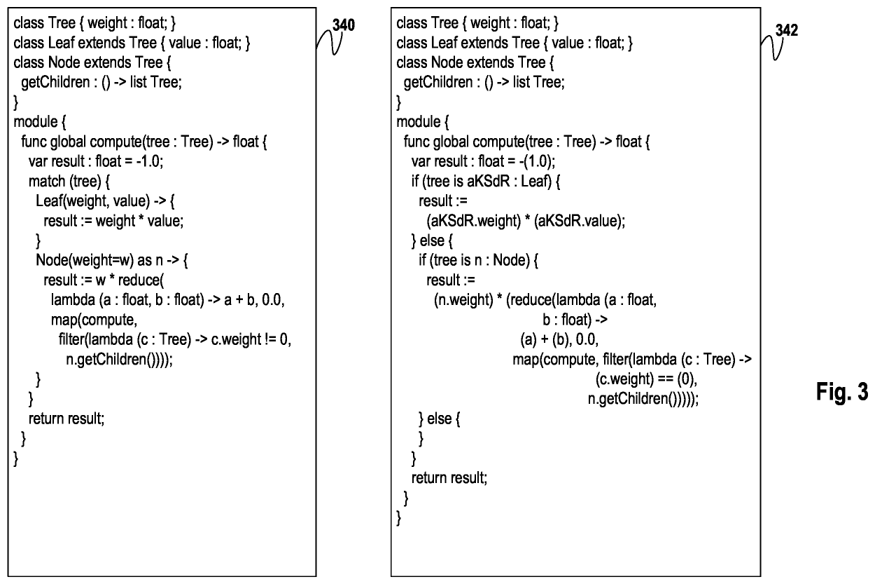

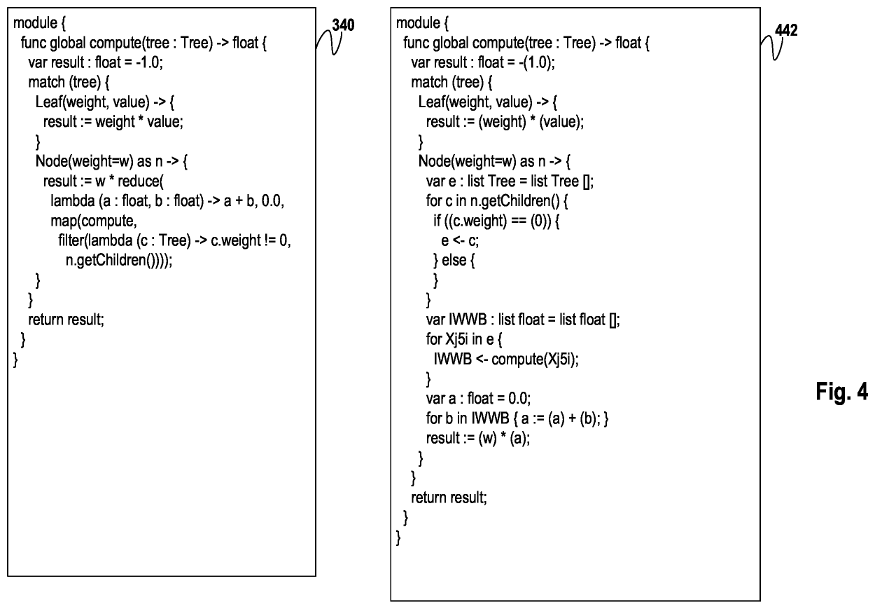

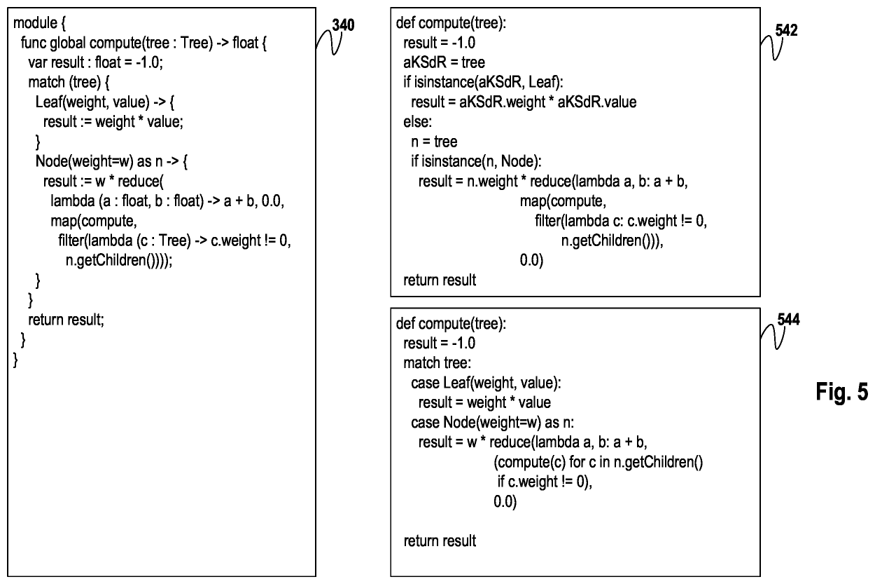

FIGS. 3-6 depict examples of how programmatic translator 103 may translate a source code snippet in syntactically constrained pseudocode 340 into various other forms, e.g., for use in generating additional training examples, training neural translation models, etc. In FIG. 3, source code snippet in syntactically constrained pseudocode 340 is depicted on the left and provides functionality (the specifics of which are not particularly relevant here) that includes a lambda expression, “lambda (a: float, b: float)->a+b,” a “map” expression, and a “filter” expression.

At right in FIG. 3, a first translated source code snippet in syntactically constrained pseudocode 342 has been generated, e.g., in response to a translate command that includes a parameter requesting that match statements are translated to if/else statements. Consequently, first translated source code snippet in syntactically constrained pseudocode 342 includes two if/else statements, rather than the match statement contained in snippet 340 (reduce, map and filter expressions are still included in snippet 342). FIG. 4 is similar to FIG. 3, except the translate command included a parameter of “loops.” Consequently, a second translated source code snippet in syntactically constrained pseudocode 442 at right includes for loop(s), rather than the lambda, map, and filter expressions contained in snippet 340.

FIGS. 3 and 4 demonstrate how in various implementations, a single syntactically constrained training source code snippet (340) may be programmatically and idiomatically translated into multiple different generic forms, each semantically equivalent to the others. Thus, in various implementations, in addition to a single syntactically constrained training source code snippet being generated from some other programming language snippet (e.g., additional reference PL snippet 224), that single syntactically constrained training source code snippet can also be used to generate additional syntactically constrained training source code snippets. These additional syntactically constrained training source code snippets may in turn be programmatically translated, e.g., by programmatic translator 103, into yet additional synthetic training source code snippets (e.g., 232, 234 in FIG. 2), further expanding the pool of available training data for the downstream neural translation model(s) 236.

FIG. 5 depicts an example where the source code snippet in syntactically constrained pseudocode 340 is once again depicted on the left. This time, however, two programmatic translation commands are issued to translate source code snippet in syntactically constrained pseudocode 340 to Python twice. The first programmatic translation command does not include any parameters about idiomatic translation. Accordingly, a first translated synthetic source code snippet in Python 542 at top right includes lambda, map, and filter expressions. The second programmatic translation command, by contrast, includes a request to specify that match statements should be translated to pattern matching statements in Python, and another request that the map/filter/reduce statement should be translated to list comprehensions. Consequently, a second translated synthetic source code snippet in Python 544 at bottom right does not include the map and filter expressions (the reduce expression is still present, as this cannot be expressed using comprehensions).

FIG. 6 illustrates additional examples of how source code snippet in syntactically constrained pseudocode 340 (not depicted in FIG. 6) may be programmatically translated into a different programming language, Java. Two programmatic translation commands have been issued. The first programmatic translation command includes parameters indicating that the map/filter/reduce expressions should be translated using the Java streaming API. Accordingly, a translated synthetic source code snippet in Java 642 at left includes lambda expressions and calls to the map, filter, and reduce methods of the Java streaming API. The second programmatic translation command includes a “loops” parameter. Consequently, a second translated synthetic source code snippet in Java 646 at right includes for loop(s) and does not include the map and filter expressions.

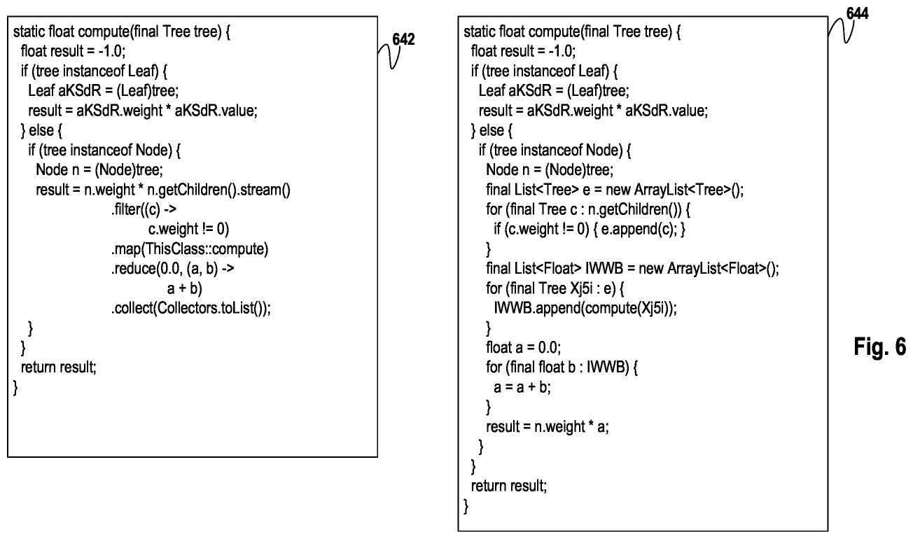

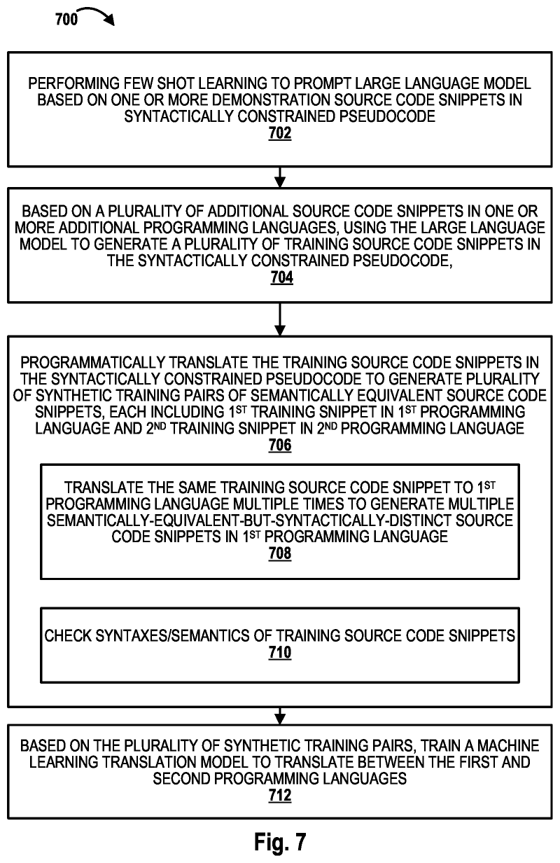

FIG. 7 is a flowchart illustrating an example method 700 of practice selected aspects of the present disclosure, in accordance with various implementations. For convenience, the operations of the flow chart are described with reference to a system that performs the operations. This system may include various components of various computer systems, such as one or more components of code knowledge system 100. Moreover, while operations of method 700 are shown in a particular order, this is not meant to be limiting. One or more operations may be reordered, omitted or added.

At block 702, the system, e.g., by way of large language module 102, may perform few shot learning to prompt a large language model (226 in FIG. 2) based on one or more demonstration source code snippets in syntactically constrained pseudocode. The few shot learning may prompt the large language model to generate additional source code snippets in the syntactically constrained pseudocode. It should be noted that implementations described herein are not limited to few shot learning. In other implementations, more than a few demonstrations may be provided. For example, a large number of demonstration pairs may be generated and used for supervised training of a new language model (e.g., a neural translation model).

Based on a plurality of additional source code snippets in one or more additional programming languages, at block 704, the system, e.g., by way of large language module 102, may use the large language model (226) to generate a plurality of training source code snippets (228 in FIG. 2) in the syntactically constrained pseudocode. The training source code snippets in the syntactically constrained pseudocode may semantically-equivalent to the plurality of additional source code snippets in the one or more additional programming languages. As noted elsewhere herein, these training source code snippets may number in the thousands, millions, or even higher, in order to provide robust training data to train one or more downstream neural translation models.

Also as noted elsewhere, the plurality of additional source code snippets in one or more additional programming languages may be provided explicitly (e.g., 224 in FIG. 2), e.g., as a batch of source code files, or a batch file identifying a plurality of source code files contained in a code base. Alternatively, the plurality of additional source code snippets in one or more additional programming languages may be selected automatically (e.g., randomly, systematically) from one or more code bases 108/112.

At block 706, the system, e.g., by way of programmatic translator 103, may programmatically translate the plurality of training source code snippets in the syntactically constrained pseudocode to generate a plurality of synthetic training pairs of semantically equivalent source code snippets (230 in FIG. 2). In various implementations, each synthetic training pair of the plurality of synthetic training pairs may include a first training snippet (232 in FIG. 2) in a first programming language and a second training snippet (234 in FIG. 2) in a second programming language. The plurality of synthetic training pairs of semantically equivalent source code snippets may be usable, e.g., by training module 104, to train (at block 712) a machine learning translation model (236 in FIG. 2) to translate between the first and second programming languages.

In some implementations, the programmatic translation of block 706 may include, at block 708, translating the same training source code snippet in the syntactically constrained pseudocode to a first programming language multiple times to generate multiple semantically-equivalent-but-syntactically-distinct source code snippets in the first programming language. An example of this was depicted in FIG. 5, wherein the same training source code snippet in the syntactically constrained pseudocode 340 was translated into Python twice to generate synthetic training snippets 542 and 544 in Python. Another example of this was depicted in FIG. 6, wherein the same training source code snippet in the syntactically constrained pseudocode 340 was translated into Java twice to generate synthetic training snippets 642 and 644 in Java.

Additionally or alternatively, in some implementations, the programmatic translation of block 706 may include, at block 710, checking syntaxes and/or semantic of training source code snippets (which may occur prior to any attempted translation in some implementations). In some implementations, snippets having syntactic and/or semantic errors may be discarded. Given the potentially enormous amount of training snippets that can be generated using techniques described herein, this may be acceptable, even if a substantial portion of the snippets have errors. In other implementations, even those snippets having errors may nonetheless be used to generating training data, with the idea being even erroneous training data may be beneficial for training a neural translation model.

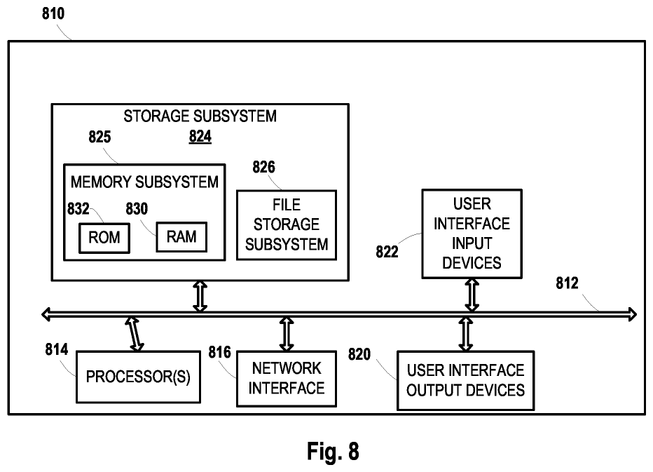

FIG. 8 is a block diagram of an example computing device 810 that may optionally be utilized to perform one or more aspects of techniques described herein. Computing device 810 typically includes at least one processor 814 which communicates with a number of peripheral devices via bus subsystem 812. These peripheral devices may include a storage subsystem 824, including, for example, a memory subsystem 825 and a file storage subsystem 826, user interface output devices 820, user interface input devices 822, and a network interface subsystem 816. The input and output devices allow user interaction with computing device 810. Network interface subsystem 816 provides an interface to outside networks and is coupled to corresponding interface devices in other computing devices.

User interface input devices 822 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 810 or onto a communication network.

User interface output devices 820 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 810 to the user or to another machine or computing device.

Storage subsystem 824 stores programming and data constructs that provide the functionality of some or all of the modules described herein. For example, the storage subsystem 824 may include the logic to perform selected aspects of the method of FIG. 7, as well as to implement various components depicted in FIGS. 1-2.

These software modules are generally executed by processor 814 alone or in combination with other processors. Memory 825 used in the storage subsystem 824 can include a number of memories including a main random access memory (RAM) 830 for storage of instructions and data during program execution and a read only memory (ROM) 832 in which fixed instructions are stored. A file storage subsystem 826 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 826 in the storage subsystem 824, or in other machines accessible by the processor(s) 814.

Bus subsystem 812 provides a mechanism for letting the various components and subsystems of computing device 810 communicate with each other as intended. Although bus subsystem 812 is shown schematically as a single bus, alternative implementations of the bus subsystem may use multiple buses.

Computing device 810 can be of varying types including a workstation, server, computing cluster, blade server, server farm, or any other data processing system or computing device. Due to the ever-changing nature of computers and networks, the description of computing device 810 depicted in FIG. 8 is intended only as a specific example for purposes of illustrating some implementations. Many other configurations of computing device 810 are possible having more or fewer components than the computing device depicted in FIG. 8.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors and comprising:
performing few shot learning to prompt a large language model based on one or more demonstration source code snippets in syntactically constrained pseudocode, wherein the few shot learning prompts the large language model to generate additional source code snippets in the syntactically constrained pseudocode;
based on a plurality of additional source code snippets in one or more additional programming languages, using the large language model to generate a plurality of training source code snippets in the syntactically constrained pseudocode, wherein the training source code snippets in the syntactically constrained pseudocode are semantically-equivalent to the plurality of additional source code snippets in the one or more additional programming languages; and
programmatically translating the plurality of training source code snippets in the syntactically constrained pseudocode to generate a plurality of synthetic training pairs of semantically equivalent source code snippets, wherein each synthetic training pair of the plurality of synthetic training pairs includes a first training snippet in a first programming language and a second training snippet in a second programming language;
wherein the plurality of synthetic training pairs of semantically equivalent source code snippets are usable to train a machine learning translation model to translate between the first and second programming languages.

2. The method of claim 1, wherein the one or more demonstration source code snippets in the syntactically constrained pseudocode are paired with semantically equivalent source code snippets in a reference programming language, wherein the few shot learning prompts the large language model to translate from the reference programing language to the syntactically constrained pseudocode, and wherein the plurality of additional source code snippets in the one or more additional programming language comprise a plurality of source code snippets in the reference programming language.

3. The method of claim 2, wherein the first programming language is the reference programming language.

4. The method of claim 3, wherein the second programming language is a different version of the reference programming language.

5. The method of claim 3, wherein the second programming language is a different programming language than the reference programming language.

6. The method of claim 1, wherein the plurality of additional source code snippets are part of a corpus of source code used to train the large language model prior to the few shot learning.

7. The method of claim 1, wherein programmatically translating the plurality of training source code snippets in the syntactically constrained pseudocode comprises checking syntaxes of the training source code snippets in the syntactically constrained pseudocode.

8. The method of claim 7, wherein programmatically translating the plurality of training source code snippets in the syntactically constrained pseudocode further comprises discarding the training source code snippets in the syntactically constrained pseudocode with invalid syntaxes.

9. The method of claim 1, wherein programmatically translating the plurality of training source code snippets in the syntactically constrained pseudocode comprises, for each of the training source code snippets in the synthetically constrained pseudocode:
generating a first abstract syntax tree;
transforming the first abstract syntax tree to a second abstract syntax tree; and
traversing the second abstract syntax tree to generate the first training snippet in the first programming language for a respective synthetic training pair.

10. The method of claim 1, wherein programmatically translating the plurality of training source code snippets comprises converting a generic map, filter, or reduce statement in the syntactically constrained pseudocode to a first programming language idiom in the first training snippet.

11. The method of claim 10, wherein programmatically translating the plurality of training source code snippets comprises converting the generic map, filter, or reduce statement in the syntactically constrained pseudocode to a second programming language idiom in the second training snippet.

12. The method of claim 1, wherein programmatically translating the plurality of training source code snippets comprises programmatically translating the same training source code snippet to the first programming language multiple times, each time with different translation parameter(s), to generate multiple semantically-equivalent-but-syntactically-distinct source code snippets in the first programming language, wherein each of the multiple semantically-equivalent-but-syntactically-distinct source code snippets in the first programming language is paired with a semantically equivalent source code snippet in the second programming language to form one of the plurality of synthetic training pairs.

13. A system comprising one or more processors and memory storing instructions that, in response to execution by the one or more processors, cause the one or more processors to:
perform few shot learning to prompt a large language model based on one or more demonstration source code snippets in syntactically constrained pseudocode, wherein the few shot learning prompts the large language model to generate additional source code snippets in the syntactically constrained pseudocode;
based on a plurality of additional source code snippets in one or more additional programming languages, use the large language model to generate a plurality of training source code snippets in the syntactically constrained pseudocode, wherein the training source code snippets in the syntactically constrained pseudocode are semantically-equivalent to the plurality of additional source code snippets in the one or more additional programming languages; and
programmatically translate the plurality of training source code snippets in the syntactically constrained pseudocode to generate a plurality of synthetic training pairs of semantically equivalent source code snippets, wherein each synthetic training pair of the plurality of synthetic training pairs includes a first training snippet in a first programming language and a second training snippet in a second programming language;
wherein the plurality of synthetic training pairs of semantically equivalent source code snippets are usable to train a machine learning translation model to translate between the first and second programming languages.

14. The system of claim 13, wherein the one or more demonstration source code snippets in the syntactically constrained pseudocode are paired with semantically equivalent source code snippets in a reference programming language, wherein the few shot learning prompts the large language model to translate from the reference programing language to the syntactically constrained pseudocode, and wherein the plurality of additional source code snippets in the one or more additional programming language comprise a plurality of source code snippets in the reference programming language.

15. The system of claim 14, wherein the first programming language is the reference programming language.

16. The system of claim 13, wherein the plurality of additional source code snippets are part of a corpus of source code used to train the large language model prior to the few shot learning.

17. The system of claim 13, wherein the instructions to programmatically translate include instructions to:
check syntaxes of the training source code snippets in the syntactically constrained pseudocode;
check the training source code snippets for semantic correctness; and/or
perform type checking of the training source code snippets.

18. The system of claim 17, wherein the instructions to programmatically translate include instructions to discard the training source code snippets in the syntactically constrained pseudocode with invalid syntaxes, semantic errors, and/or type mismatches.

19. The system of claim 13, wherein the instructions to programmatically translate include instructions to, for each of the training source code snippets in the synthetically constrained pseudocode:
generate a first abstract syntax tree;
transform the first abstract syntax tree to a second abstract syntax tree; and
traverse the second abstract syntax tree to generate the first training snippet in the first programming language for a respective synthetic training pair.

20. At least one non-transitory computer-readable medium comprising instructions that, when executed by one or more processors, cause the one or more processors to:
perform few shot learning to prompt a large language model based on one or more demonstration source code snippets in syntactically constrained pseudocode, wherein the few shot learning prompts the large language model to generate additional source code snippets in the syntactically constrained pseudocode;
based on a plurality of additional source code snippets in one or more additional programming languages, use the large language model to generate a plurality of training source code snippets in the syntactically constrained pseudocode, wherein the training source code snippets in the syntactically constrained pseudocode are semantically-equivalent to the plurality of additional source code snippets in the one or more additional programming languages; and
programmatically translate the plurality of training source code snippets in the syntactically constrained pseudocode to generate a plurality of synthetic training pairs of semantically equivalent source code snippets, wherein each synthetic training pair of the plurality of synthetic training pairs includes a first training snippet in a first programming language and a second training snippet in a second programming language;
wherein the plurality of synthetic training pairs of semantically equivalent source code snippets are usable to train a machine learning translation model to translate between the first and second programming languages.
